(19) United States
(12) Patent Application Publication
(10) Pub. No.: US 2008/0249850 A1
(43) Pub. Date: Oct. 9, 2008

(54) Providing Information About Content Distribution

(75) Inventors: Andrew Szybalski, Mountain View, CA (US); Howard P. Mullings, Mountain View, CA (US); Ariel H. Bardin, Belmont, CA (US); Mohammed Abdoolcarim, Palo Alto, CA (US); Nadine Harik, Palo Alto, CA (US); Susanne Brokaw, Los Gatos, CA (US); Steve Miller, Menlo Park, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/695,861

(22) Filed: Apr. 3, 2007

(51) Int. Cl. G06Q 30/00

(52) U.S. Cl. 705/14

(57) ABSTRACT

Providing information about content distribution includes receiving a request for information regarding at least one content distribution activity that has previously been created to be performed in at least one of a plurality of media types. The method includes obtaining content distribution information regarding the at least one content distribution activity. The method includes presenting the content distribution information in a graphical user interface that is configured to display content distribution activities for each of the media types. Managing multiple media type distribution in an advertising campaign includes identifying plural distribution media types for inclusion in at least one campaign. The method includes setting distribution characteristics in each of the plural distribution media types for the campaign. The method includes presenting campaign information to a user that aggregates results over more than one of the plural distribution media types.

### TECHNICAL FIELD

This document relates to content distribution.

### BACKGROUND

Advertising is traditionally done in one or more specific kinds of media. For example, print ads have been occurring in newspapers and other publications for a long time. The advertisement is typically brought about because a seller (the advertiser) desires to spread an advertising message to a more or less wide audience in hopes of increasing sales, or gaining a better reputation, or both. In the past, the advertiser might contact a traditional advertising agency whose role is to broker the contact between the advertiser and one or more publishers (e.g., the newspaper company or a branch thereof). There may also be one or more additional players in the scenario that perform some function in bringing the advertisement from the advertiser to its ultimate publication.

While print advertisements (e.g., in newspapers or on billboards) are one of the earlier forms of market communication, other media have developed along the way and are currently significant outlets for commercial advertisements. For example, distributors of radio and television programming have since long been publishing ads, and in the online environment advertising has taken on a substantial presence with the vast increase in the use of that medium that was fueled by the so-called Internet revolution.

The increase in use of computer-based devices and the increasing prevalence of advertisements in such fields have also brought some opportunities for tracking and evaluating advertisement efforts. For example, ads that are published online are sometimes created with one or more hyperlinks that the viewer can click on to get more information or to purchase the offered goods or services. Because this action by the user is performed in a controlled digital processor-based environment, the user's act of clicking can be detected if so desired and the fact that the user clicked can later be used for one or more purposes, such as to measure whether the ad generates sufficient interest among the public or to determine the price that should be paid for publishing it.

### SUMMARY

In a first aspect, a computer-implemented method for providing information about content distribution includes receiving a request for information regarding at least one content distribution activity that has previously been created to be performed in at least one of a plurality of media types. The method includes obtaining content distribution information regarding the at least one content distribution activity. The method includes presenting the content distribution information in a graphical user interface that is configured to display content distribution activities for each of the media types.

Implementations can include any, all or none of the following features. The request can be associated with an account registered in a multimedia content distribution platform and the method can further include identifying, before presenting the content distribution information, the at least one content distribution activity in the multimedia content distribution platform using the account. The at least one content distribution activity can be an advertisement campaign created to be presented in one of the plurality of media types. The plurality of media types can include at least one selected from: an online medium, a wireless medium, an audio medium, a radio medium, a visual medium, an audiovisual medium, a television medium, a telephone medium, a print medium, and combinations thereof. Several content distribution activities can have previously been created to be performed in at least some of the plurality of media types and the method can further include aggregating at least part of content distribution information for each of the several content distribution activities into an aggregate content distribution information, and presenting the aggregate content distribution information in the graphical user interface. The method can further include receiving an input to change a setting of the at least one content distribution activity, the input being generated under guidance of the graphical user interface, and modifying, in response to the input, an instruction configured for causing the at least one content distribution activity to be performed. Modifying the instruction can include performing at least one selected from the group consisting of: starting the activity, pausing the activity, ending the activity, deleting the activity, setting a budget for the activity changing a characteristic of the activity, and combinations thereof. The method can further include receiving an input to create another content distribution activity, the input being generated under guidance of the graphical user interface and indicating at least one of the plurality of media types to be used for the other content distribution activity, and creating, in response to the input, the other content distribution activity to be performed in the indicated media type.

In a second aspect, a computer program product is tangibly embodied in a computer-readable medium and includes instructions that when executed by a processor perform a method for providing information about content distribution. The method includes receiving a request for information regarding at least one content distribution activity that has previously been created to be performed in at least one of a plurality of media types. The method includes obtaining content distribution information regarding the at least one content distribution activity presenting the content distribution information in a graphical user interface that is configured to display content distribution activities for each of the media types.

In a third aspect, a system includes a multimedia content distribution platform configured to manage at least one content distribution activity in any of a plurality of media types. The system includes a graphical user interface interacting with the a multimedia content distribution platform and configured to: (i) guide submission of a request to the multimedia content distribution platform for information regarding the at least one content distribution activity; and (ii) present content distribution information relating to the at least one content distribution activity that the multimedia content distribution platform obtains.

Implementations can include any, all or none of the following features. Several content distribution activities can have previously been created to be performed in at least some of the plurality of media types, and the multimedia content distribution platform can be configured to aggregate at least part of content distribution information for each of the several content distribution activities into an aggregate content distribution information, and present the aggregate content distribution information in the graphical user interface. The system can further include an activity management module configured to at least initiate content distribution activities in any of the plurality of media types. Content distribution activities in at least one of the plurality of media can be performed by a system other than the activity management module, and the activity management module can be configured to communicate with the other system regarding the content distribution activities in the at least one of the plurality of media. The multimedia content distribution platform can be configured for: receiving an input to change a setting of the at least one content distribution activity, the input being generated under guidance of the graphical user interface; and modifying, in response to the input, an instruction for the activity management module regarding the at least one content distribution activity. The multimedia content distribution platform can be configured for: receiving an input to create another content distribution activity, the input being generated under guidance of the graphical user interface and indicating at least one of the plurality of media types to be used for the other content distribution activity; and creating, in response to the input and for the activity management module, the other content distribution activity to be performed in the indicated media type.

In a fourth aspect, a computer program product is tangibly embodied in a computer-readable medium and includes instructions that, when executed, generate on a display device a graphical user interface for providing information about content distribution. The graphical user interface includes a plurality of areas regarding content distribution activities, each of the areas being associated with at least one of a plurality of media types and being configured for managing at least one content distribution activity that is created to be performed in the associated media type and informing about the at least one content distribution activity.

Implementations can include any, all or none of the following features. Several content distribution activities can have previously been created to be performed in at least some of the plurality of media types, and the graphical user interface can further include: an area for presenting an aggregate content distribution information, the aggregate content distribution information generated by aggregating at least part of content distribution information for each of the several content distribution activities. The graphical user interface can further include an input control for generating an input to change a setting of the at least one content distribution activity, wherein, in response to the input, an instruction configured for causing the at least one content distribution activity to be performed is modified. The graphical user interface can further include an input control for generating an input to create another content distribution activity, the input indicating at least one of the plurality of media types to be used for the other content distribution activity, wherein, in response to the input, the other content distribution activity to be performed in the indicated media type is created.

In a fifth aspect, a computer-implemented method for managing multiple media type distribution in an advertising campaign includes identifying plural distribution media types for inclusion in at least one campaign. The method includes setting distribution characteristics in each of the plural distribution media types for the campaign. The method includes presenting campaign information to a user that aggregates results over more than one of the plural distribution media types.

Implementations can include any, all or none of the following features. The method can further include managing activities for the plural distribution media types. Managing the activities can include at least initiating the activities to be performed in the respective plural distribution media types. Managing the activities can further include changing an aspect of an activity for at least one of the plural distribution media types. The change can be applied to several of the plural distribution media types and the change can be initiated by a single command generated by a user.

In a sixth aspect, a computer program product is tangibly embodied in a computer-readable medium and includes instructions that when executed by a processor perform a method for managing multiple media-type distribution in an advertising campaign. The method includes identifying plural distribution media types for inclusion in at least one campaign. The method includes setting distribution characteristics in each of the plural distribution media types for the campaign. The method includes presenting campaign information to a user that aggregates results over more than one of the plural distribution media types.

Implementations can provide any, all or none of the following advantages: providing an improved presentation of content distribution information; providing an improved creation, management and/or overview of an advertisement campaign for an advertiser or a publisher; providing a platform for multimedia distribution of content; and facilitating an improved brokering between content providers and content distributors.

The details of one or more embodiments are set forth in the accompanying drawings and the description below. Other features and advantages will be apparent from the description and drawings, and from the claims.

### DESCRIPTION OF DRAWINGS

FIG. 1 is a block diagram showing an example of a system for content distribution.

FIG. 2 shows an example of a graphical user interface for presenting content distribution information and managing content distribution activities.

FIG. 3 is a flow chart showing an example of a process for presenting content distribution information and managing content distribution activities.

FIG. 4 shows an example of a graphical user interface for presenting content publishing information and managing content publishing activities.

FIG. 5 is a schematic diagram of a computing system that can be used in connection with computer-implemented methods described in this document.

Like reference symbols in the various drawings indicate like elements.

### DETAILED DESCRIPTION

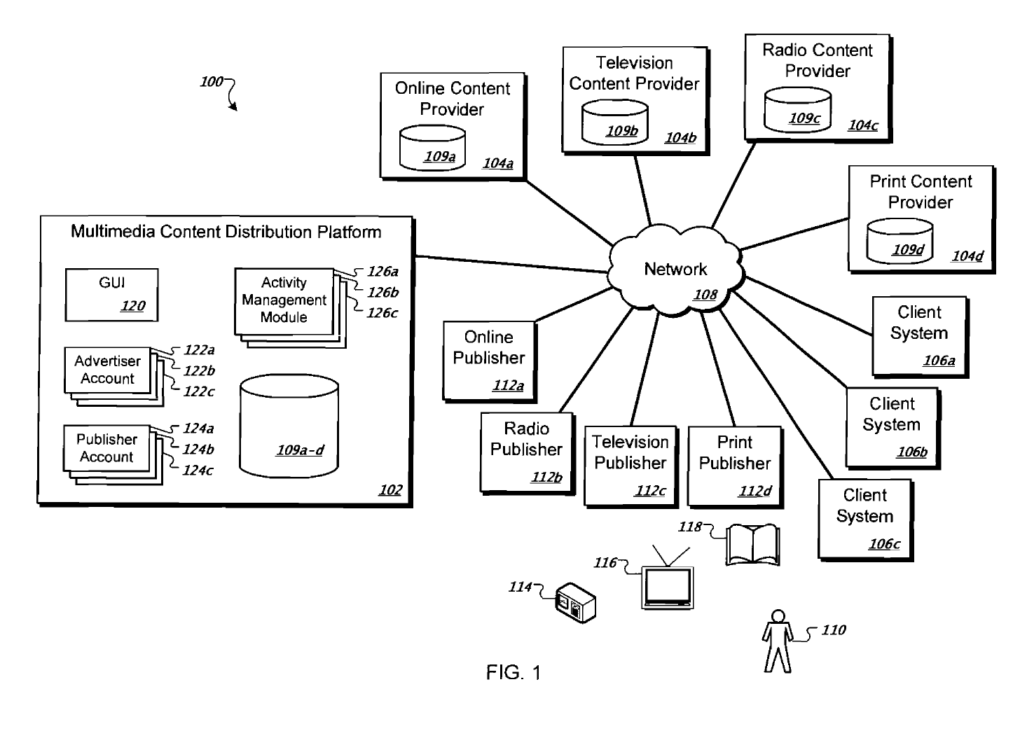

FIG. 1 is a block diagram showing an example of a system 100 for content distribution. The system 100 includes a multimedia content distribution (MCD) platform 102, one or more content provider systems 104a-d, and one or more client systems 106a-c. The MCD platform 102, the content providers 104a-d, and the client systems 106a-c are here capable of engaging in communication through a network 108, such as a private network or the Internet. The content provider systems 104a-d provide content 109a-d through various communication channels, such as by printed publications, online services, radio or television broadcasting. The MCD platform 102 manages and coordinates user-provided content (e.g., advertisements) and causes it to be distributed with some or all of the content 109a-d. For example, in some implementations the MCD platform 102 can be considered a broker between advertisers (e.g., those interested in advertising their goods or services) and publishers (e.g., those engaged in publishing content and who might include the advertiser's message in the distribution). In such implementations the MCD platform 102 can be used by either or both of these groups in organizing and carrying out the distribution of content. Other system architectures can be used in some implementations, including some that do not involve a client-server configuration.

The content may be presented using one or more media types that the MCD platform 102 is configured to work with. This can include media types such as an online medium, a wireless medium, an audio medium, a radio medium, a visual medium, an audiovisual medium, a television medium, a telephone medium, a print medium, or a combination of these, to name a few examples. In some implementations, the MCD platform 102 distributes the content to users. For example, the MCD platform 102 may distribute online material to a user 110 of the client system 104c and this online material can include content (e.g., an advertisement) on behalf of a specific entity, such as an advertiser. In some implementations, the MCD platform 102 distributes content to one or more publishers 112a-d for further distribution. The publishers 112a-d can then include the received content with the content that they distribute to users. For example, the online publisher 112a may distribute online content received from the MCD platform 102 to the user 110 through the client system 106c; the radio publisher 112b may distribute audio content to the user 110 through a radio medium for receipt using a radio receiver 114; the television publisher 112c may distribute audio and/or video content to the user 110 through a television medium for receipt using a television receiver 116; and the print publisher 112d may distribute print content to the user 110 through a print medium 118 (e.g., a newspaper or magazine). In some implementations, the content providers 104a-d and/or the publishers 112a-d provide or present content, respectively, using multiple media types. The television and radio receivers need not be terrestrial, and may be, for example, satellite based, Internet Protocol (IP) network based, or part of a media on demand system. Other media types, such as print, billboard, and the like, can be used.

In some implementations, one or more of the content provider systems 104a-d are operated by publishers who are engaged in distributing advertising content on behalf of advertisers for valuable compensation. For example, the advertisers can provide ad content to the MCD platform 102, and the MCD platform 102 can insert an advertisement and distribute the material to the public. As another example, the MCD platform 102 can distribute the ad content to one or more of the publishers 112a-d for the publisher(s) to insert the ad into other content and arrange for its distribution.

In some implementations, the MCD platform 102 stores or has access to at least some information regarding the distribution of the content. This can include the number of times a publisher (or the MCD platform 102) presented a particular content item, an indication of whether or not the user 110 acted on the content presentation (e.g., clicked on an online ad or placed a telephone call to a business), a range of dates over which the content item is presented, and the amount the content provider paid for the content presentation or user action resulting from the content presentation, to name a few examples.

A set of ad content and its distribution information may be part of an ad campaign that can be performed in one or more types of media to reach specific or unspecific categories of people. Moreover, an ad campaign is an example of a content distribution activity, in that the ad comprises content that is set into distribution in an organized effort. As such, the MCD platform 102 in some implementations brokers advertisement distribution and provides overview and control of the advertising campaign(s).

The MCD platform 102 can present a graphical user interface (GUI) 120 regarding content distribution. For example, content providers or publishers can access the GUI and control and/or review aspects of an advertising campaign. In some implementations, the GUI 120 allows the content providers to manage the distribution of the content 109a-d. In some implementations, the GUI 120 allows the publishers to manage the publishing of the content 109a-d. The MCD platform 102 may present the GUI 120 at one or more of the client systems 106a-c, the content providers 104a-d, and/or the publishers 112a-d.

For example, the GUI 120 presents to a content provider (or publisher) the content distribution information associated with that content provider. This can allow the content provider to overview and/or control the content distribution activities (such as advertising campaigns) it has ordered, or it can allow the publisher to overview and/or control the content distribution activities it is currently carrying out or has scheduled for the future. Particularly, the MCD platform 102 can include content provider accounts 122a-c and publisher accounts 124a-c. Each of the content provider accounts 122a-c can be associated with one or more content distribution activities for a particular content provider and each of the publisher accounts 124a-c can be associated with content distribution information for a particular publisher. For example, the content provider account 122a may identify the content distribution activities associated with the content provider 104a. The accounts 122a-c and/or 124a-c can be created upon request from a publisher or an advertiser, respectively, to allow them access to the MCD platform 102 where they can create advertising campaigns and monitor existing campaigns.

For example, upon request from an administrator of the content provider 104a, the MCD platform 102 uses the GUI 120 to present the content distribution activities associated with the content provider 104a to the administrator. The administrator may further make a request using the GUI 120 for the MCD platform 102 to perform a management action regarding one or more content distribution activities associated with the content provider 104a. The MCD platform 102 here includes one or more activity management modules 126a-c that can perform management operations on content distribution activities. For example, the administrator may make an input requesting that the MCD platform 102 create a new content distribution activity, such as a new ad campaign in a print medium. The MCD platform 102 may invoke the activity management module 126a to create a new content distribution activity. The other activity management modules 126b-c may perform operations, such as pausing resuming the distribution of content in a content distribution activity, resuming the distribution of content in a content distribution activity, or changing the properties of a content distribution activity (e.g., setting a new budget for daily charges resulting from an ad campaign).

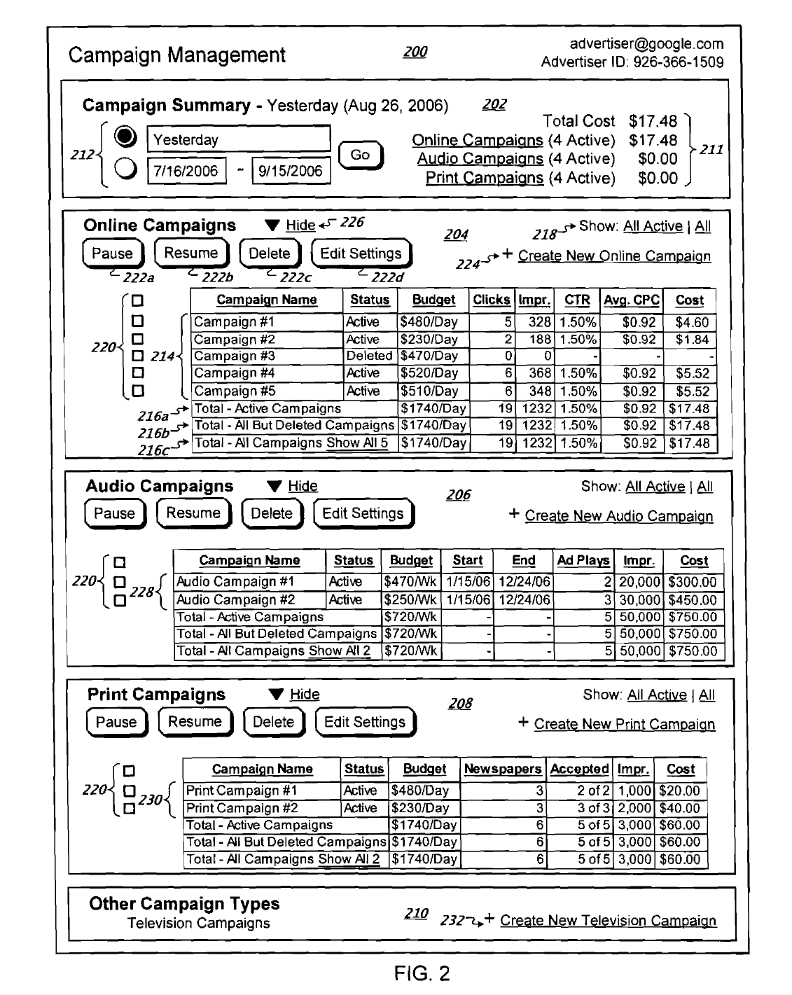

FIG. 2 shows an example of a graphical user interface (GUI) 200 for presenting content distribution information and managing content distribution activities. Particularly, the GUI 200 can present ad distribution information associated with a particular advertiser and can allow the advertiser to manage ad campaigns associated with the advertiser. For example, the MCD platform 102 may initiate the GUI 200 in response to a request from an advertiser, such as a logon operation at a web site. The GUI 200 in this implementation includes a campaign summary area 202, an online campaign area 204, an audio campaign area 206, a print campaign area 208, and an other campaign types area 210. More or fewer areas than shown can be used as necessary.

The campaign summary area 202 presents a summary of content distribution information for the ad campaigns of the advertiser. The advertiser may have ad campaigns using multiple forms of media, such as online ad campaigns, audio ad campaigns, and print ad campaigns. The campaign summary area 202 presents total costs 211 for the ad campaigns of each media type and the ad campaigns as a whole. The cost of an ad campaign here indicates the amount of money the advertiser is billed for presenting ad content at one or more publishers. The total costs 211 can be calculated over a particular time period, such as up until the previous day. The campaign summary area 202 includes a time period selection control 212. The advertiser may make an input using the selection control 212 to indicate a time period over which to calculate the total costs 211, such as start and end dates or a date range (e.g., yesterday, previous week, or previous month). In addition, the selected time period may also be used to determine content distribution information to be presented in the campaign areas 204, 206, 208 and 210. That is, in some implementations a particular campaign is represented in the GUI 200 only if the user specifies a time period in which the campaign is active.

The online campaign area 204 presents content distribution information for one or more online ad campaigns. The online campaign area 204 here includes an online ad campaign list 214. The list 214 shows content distribution information for online ad campaigns during the selected time period. Particularly, the list 214 here includes a row for each online ad campaign. The list 214 also includes, for example, columns in each row for information related to an online ad campaign, such as a campaign name, a status, a budget, a number of clicks, a number of impressions, a click-through-rate (CTR), an average cost-per-click (CPC), and a cost of the ad campaign during the selected time period. More or fewer columns can be used.

The “Campaign name” identifies the campaign and includes a link that navigates to additional information associated with the ad campaign, such as the ad content used in the campaign and keywords that are matched with keywords associated with publishers at which the ad content is presented. The “Status” indicates whether or not the ad campaign is actively distributing ad content. For example, the MCD platform 102 may change the status of an ad campaign to “paused” and stop distributing ads from an ad campaign when the ad campaign reaches its budget. The number of “Clicks” indicates the number of times that end users clicked on ad content presented to them. The number of impressions (Impr.) indicates the number of times that publishers presented the ad content in the ad campaign to end users. The “CTR” is the ratio of the number of clicks to the number of impressions expressed as a percentage. For example, when a user clicks on ad content, the advertiser can be billed for the action and the publisher can be credited for the action. The average CPC is the average cost of a click by an end user on an ad presented at a particular publisher site. The cost of an online ad campaign during a selected time period can be calculated as the total cost attributed to clicks on ad content performed by end users.

The GUI 200 can present aggregated content distribution information for one or more campaigns. The total costs 211 is an example of aggregated information because it is based on information from two or more campaigns. As another example, the online campaign area 204 presents totals 216a-c for active campaigns, campaigns that are not deleted, and all online type campaigns, respectively. More or fewer portions of aggregated information can be presented. Each of the totals 216a-c here includes a total budget, total clicks, total impressions, total CTR, total average CPC, and total cost. The MCD platform 102 may perform the aggregation of the totals 216a-c.

The online campaign area 204 includes a control 218 that allows an advertiser to request that the list 214 be filtered based on the status of each ad campaign. For example, an advertiser may select “all active” in the control 218 to request that the list 214 present only ad campaigns having a status of “active.” In some implementations, the total 216a is presented when the advertiser selects “all active.” Alternatively, an advertiser may make a selection such as “all but deleted” in the control 218 requesting that the list 214 present all online type ad campaigns that have a status other than “deleted.” In some implementations, the total 216b is presented when the advertiser selects “all but deleted.” In some implementations, the available selections in the control 218 can change based on the current selection. For example, if the advertiser selects “all active” the options in the control 218 may change to include “all but deleted” instead of “all active.”

The online campaign area 204 also allows an advertiser to perform one or more management operations on ad campaigns. An advertiser may indicate one or more ad campaigns on which to perform a management operation by making one or more selections using selection controls 220. The advertiser may then select any or all of a group of management controls 222a-d to perform operation(s) on the selected campaign(s). This can include commands to pause an ad campaign, resume an ad campaign, delete an ad campaign, or edit the properties of an ad campaign, to name a few examples. For example, the advertiser may select the edit control 222d and change the budget setting for one or more ad campaigns. In addition, the advertiser may select a control 224 to request that a new online ad campaign be created. In some implementations, a specific campaign control command that the user generates can be applied to campaigns in multiple types of media. In such implementations, the user may be able to start, stop or set the budget for online, radio and television campaigns using respective single controls that apply to all of the media types. For example, an advertiser may make selections using the selection controls 220 in two or more of the campaign areas 204, 206, and 208 and then select a management operation such as one of the controls 222a-d. This can allow an advertiser to manage ad campaigns having two or more different types using one management operation.

The online campaign area 204 includes a hide control 226 that minimizes the online campaign area 204. For example, the advertiser may select the hide control 226 to request that only the name of the campaign type and the show control 218 remain in the GUI 200. Minimizing the online campaign area 204 moves the other campaign areas 206 and 208 up into the space that the online campaign area 204 previously occupied in the GUI 200. In some implementations, the other campaign areas 206 and 208 include controls corresponding to the controls 218, 220, 222a-d, 224, and 226 in the online campaign area 204.

The audio campaign area 206 presents content distribution information for audio ad campaigns, such as ad campaigns presented by a radio or telephone publisher. The audio campaign area 206 includes an audio ad campaign list 228. The list 228 shows content distribution information for audio ad campaigns during the time period selected in the control 212 within the campaign summary area 202. Particularly, the list 228 includes a row for each audio ad campaign. As with the online ad campaign list 214, the audio campaign list 228 includes columns in each row for a campaign name, a status, a budget, and a cost of the ad campaign during the selected time period. The list 228 also includes a start date for each audio ad campaign, an end date, a number of times ad content was published (e.g., ad plays), and a number of times ad content in the ad campaign was presented to an end user as a result of publishing (e.g., the number of impressions).

The print campaign area 208 presents content distribution information for print ad campaigns, such as ad campaigns presented by a newspaper or magazine publisher. The print campaign area 208 includes a print ad campaign list 230. The list 230 shows content distribution information for print ad campaigns during the time period selected in the control 212 within the campaign summary area 202. Particularly, the list 230 includes a row for each print ad campaign. As with the online ad campaign list 214, the print campaign list 230 includes columns in each row for a campaign name, a status, a budget, and a cost of the ad campaign during the selected time period. The list 230 also includes a number of publishers (e.g., newspapers) presenting the ad content from the print ad campaign, a number of print ads accepted for presentation, and a number of times the accepted print ads were presented (e.g., the number of impressions).

The other campaign area 210 allows an advertiser to create ad campaigns for other media types in which the advertiser is not already advertising in this implementation, the other campaign area 210 includes a control 232 that allows an advertiser to create a new campaign, such as a television ad campaign.

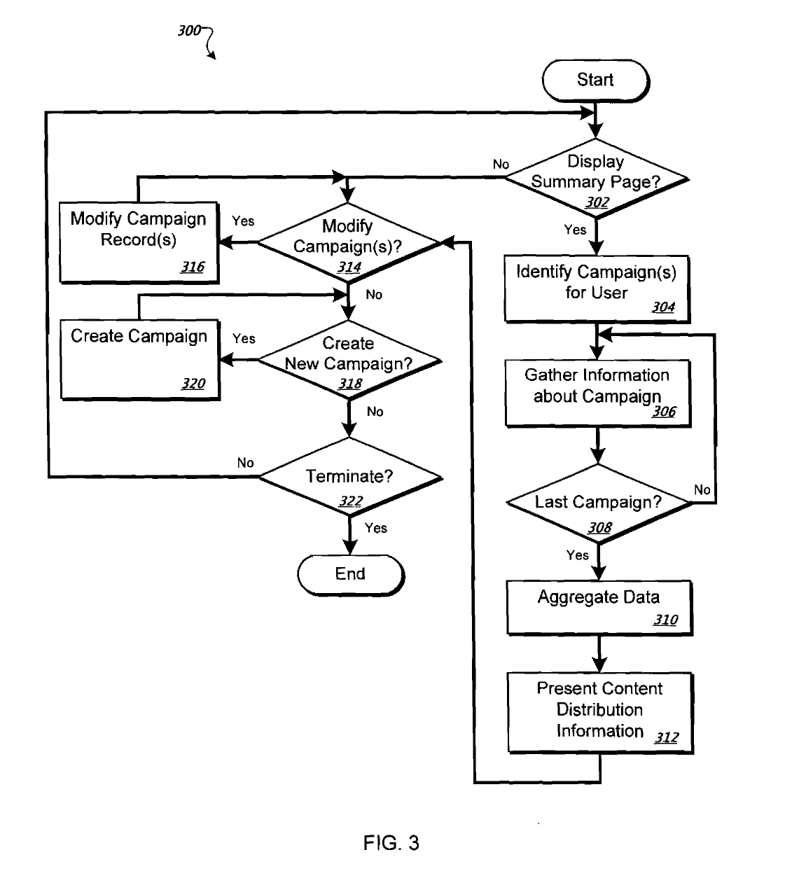

FIG. 3 is a flow chart showing an example of a process 300 that can be used for presenting content distribution information and/or managing content distribution activities. The process 300 may be performed, for example, by a processor reading executable instructions in a system such as the system 100. For clarity of presentation, the description that follows uses the system 100, in which advertisements can be distributed in various media channels, as the basis of an example for describing the process 300. However, another system, or combination of systems, may be used to perform the process 300.

In step 302, it is determined whether a summary page should be displayed. For example, the GUI 120 (FIG. 1) can be displayed to present a summary page that includes any or all of the areas 202-208 (FIG. 2). For example, the summary page can be associated with any or all of the advertiser accounts 122a-c and/or the publisher accounts 124a-c (FIG. 1) and the process 300 can be performed when an advertiser/publisher logs into the MCD platform 102 (FIG. 1). In some implementations, this determination may involve determining whether a user has logged into the MCD platform 102. That is, where a summary page is to be displayed for every user, then the MCD platform 102 may check whether the user has logged into the MCD platform 102 and provide the summary page associated with the account of the user.

If it is decided in step 302 that the summary page is to be displayed, then one or more campaigns or other content distribution activities can be identified for the user in step 304. For example, one or more of the accounts 122a-c and 124a-c can be accessed to determine what advertising campaign(s) the current user has defined in the MCD platform 102.

In step 306, information about the content distribution(s) is obtained. This can involve contacting any or all of the publishers 112a-d (FIG. 1) to inquire about some aspect of the user's campaign(s). For example, the number of clicks registered to date for an online advertisement campaign can be determined in step 306. In some implementations and for some publishers, the gathering of content distribution information can be done at regular intervals, such as daily, weekly or monthly. In other implementations or for other publishers, the information can be gathered at random intervals or the publisher can be responsible for pushing this information (at the publisher's discretion) to the organization or entity performing the process 300. For example, the MCD platform 102 can be configured to poll any or all of the publishers 112a-d for, or receive from them, the required content distribution information.

In step 308 it is determined whether the last campaign for this user has been processed. If not, step 306 can be repeated. As mentioned above, the information gathering (e.g., steps 306 and 308) can be performed before, during or after the user logs into their account to see the content distribution information.

After the last current campaign for the user has been reached in step 308, data can optionally be aggregated in step 310. This can involve selecting certain data portions in two or more campaigns and using the data portions to generate an aggregate data portion. For example, the total costs 211 and 216a-c can be aggregated from two or more campaigns run on behalf of a particular user and can be presented to give that user and overview of the total cost of the campaigns involved. The aggregation can be done using content distribution activities from a single media type (e.g., from two or more online campaigns) or it can be done using content distribution activities across multiple media types (e.g., from an online campaign, a radio campaign and a TV campaign), to name a few examples.

In step 312, content distribution information is presented in a graphical user interface that is configured for use with content distribution activities for any of the media types. For example, the information can be presented in the GUI 120 (FIG. 1) or in the GUI 200 (FIG. 2). The content distribution information can be organized based on the media type it relates to, based on its size or extent, based on the time period it covers, and/or based on user preferences, to name a few examples.

In step 314, it is determined whether to modify one or more campaigns. This step can be performed after step 312, or alternatively after a decision in step 302 that the summary page is currently not to be displayed. If there should be a modification, it can be performed by modifying a campaign record in step 316. The GUI can be used to indicate that the campaign should be modified. For example, the GUI 200 can be used to start and stop campaign activities or to changes one or more other aspects of a campaign. Accordingly, the specified change(s) can be implemented by making a corresponding change in the record of the campaign held by the MCD platform 102.

In step 318, it is determined whether a new campaign should be created. This step can be performed after it is determined in step 314 that no (additional) changes are to be made in the campaign(s). Alternatively, the step 318 can be performed at another time, such as after a decision in step 302 that the summary page is currently not to be displayed. For example, the “Create new online campaign” 224 in FIG. 2 can be used to initiate creation of the new campaign. If so, the campaign can be created in step 320, for example by the MCD platform 102.

In step 322 it is determined whether to terminate the process 300. If not, the process 300 can execute the step 302, to name one example.

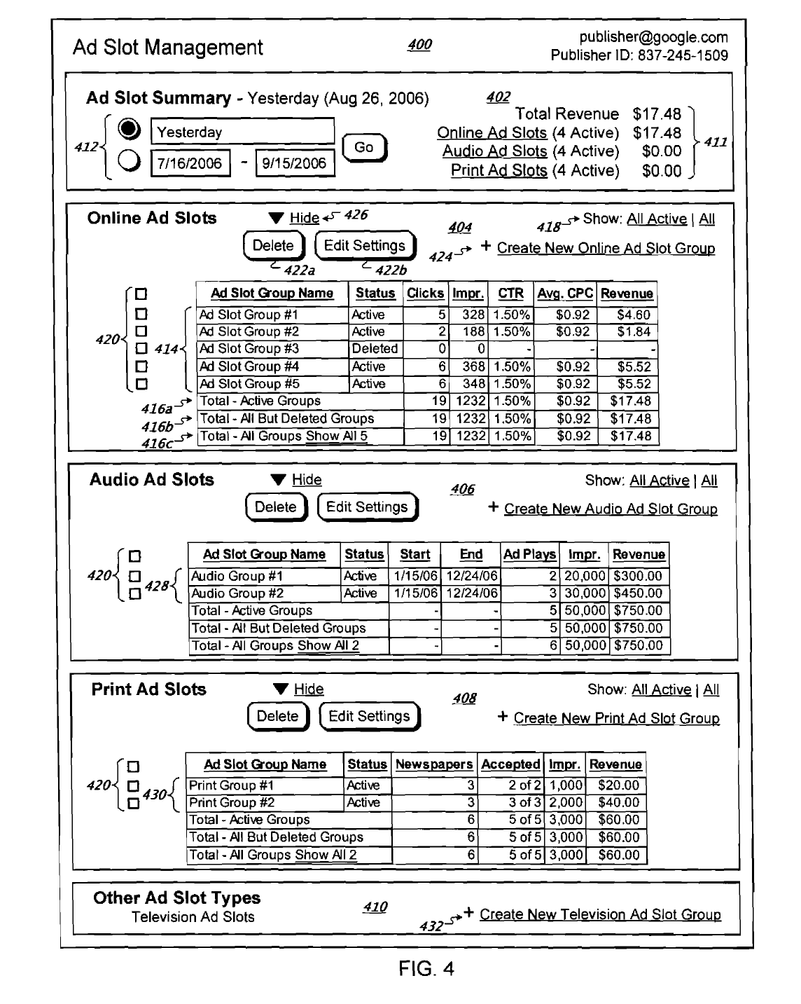

FIG. 4 shows an example of a graphical user interface (GUI) 400 for presenting content publishing information and managing content publishing activities. Particularly, the GUI 400 presents ad publishing information associated with a particular publisher and allows the publisher to manage groups of ad slots associated with the publisher. In this example, it is assumed that publishers present the ad content distributed by the MCD platform 102 in ad slots. Each ad slot can have properties that determine the type of ad media to present in the ad slot as well as the type of ad content appropriate for the publisher. For example, an online publisher may have keywords associated with a web site where a group of ad slots are available for presenting ad content from advertisers where the ad content is associated with the keywords. A publisher of radio or TV advertisements, moreover, may designate time slots for broadcasting advertisements and one or more such slots can be represented in the GUI 400. The MCD platform 102 may initiate the GUI 400 in response to a request from a publisher, such as a logon operation at a web site. In this implementation, the GUI 400 includes an ad slot summary area 402, an online ad slot area 404, an audio ad slot area 406, a print ad slot area 408, and an other ad slot types area 410. More or fewer areas can be used as necessary. Moreover, the available advertisement space can be managed in other ways than the ad slots mentioned in this example. In another implementation, a publisher can for example manage its resources in terms of orders that the publisher receives from respective advertisers, and such orders can then be presented to a user on a corresponding page.

The ad slot summary area 402 here presents a summary of content publishing information for the ad slot types of the publisher. The publisher may have ad slots using multiple forms of media, such as online ad slots, audio ad slots, and print ad slots. The ad slot summary area 402 presents total revenues 411 for the ad slots of each media type and the ad slots as a whole. The revenue of a group of ad slot represents the amount of money the publisher is paid for presenting ad content in the group of ad slots. In some implementations, the publisher is compensated when an end user performs an action in response to the presentation of the ad content, such as by selecting a hyperlink in an online ad. The total revenues 4110 are calculated over a particular time period, such as the previous day. The ad slot summary area 402 includes a time period selection control 412. The publisher may make an input using the selection control 412 indicating a time period over which to calculate the total revenues 411, such as start and end dates or a date range (e.g., yesterday, previous week, or previous month). In addition, the selected time period may also be used to determine content publishing information to be presented in the ad slot areas 404, 406, and 408.

The online ad slot area 404 here presents content publishing information for groups of online ad slots. The online ad slot area 404 includes an online ad slot list 414. The list 414 shows content publishing information for online ad slots during the selected time period. Particularly, the list 414 includes a row for each group of online ad slots. The list 414 also includes columns in each row for an ad slot group name, a status, a number of clicks, a number of impressions, a click-through-rate (CTR), an average cost-per-click (CPC), and a revenue of the ad slot group during the selected time period. The ad slot group name identifies the ad slot group and includes a link that navigates to additional information associated with the group of ad slots, such as keywords or other properties associated with the ad slots that determine the ad content to be presented in the ad slots. The status indicates whether or not the ad slot group is actively presenting ad content to end users. The number of clicks indicates the number of times that end users clicked on ad content presented in the ad slots. The number of impressions indicates the number of times that the ad slots presented ad content to end users. The CTR is the ratio of the number of clicks to the number of impressions expressed as a percentage. When a user clicks on ad content, the publisher is paid for the action and the advertiser is billed for the action. The average CPC is the average cost paid by advertisers for a click on ad content. The revenue of an ad slot group during a selected time period is the total revenue attributed to clicks on ad content performed by end users.

In addition, the online ad slot area 404 can present aggregated content publishing information for the online ad slot groups. For example, the online ad slot area 404 here presents totals 416a-c for active ad slot groups, ad slot groups that are not deleted, and all online type ad slot groups, respectively. Each of the totals 416a-c include total clicks, total impressions, total CTR, total average CPC, and total revenue. The MCD platform 102 may perform the aggregation of the totals 416a-c.

The online ad slot area 404 includes a control 418 that allows a publisher to request that the list 414 be filtered based on the status of each ad slot group. For example, a publisher may select “all active” in the control 418 to request that the list 414 present only ad slot groups having a status of “active.” In some implementations, the total 416a is presented when the publisher selects “all active.” Alternatively, a publisher may make a selection such as “all but deleted” in the control 418 requesting that the list 414 present all online type ad slot groups that have a status other than “deleted.” In some implementations, the total 416b is presented when the publisher selects “all but deleted.” In some implementations, the available selections in the control 418 change based on the current selection. For example, if the publisher selects “all active” the options in the control 418 may change to include “all but deleted” instead of “all active.”

The online ad slot area 404 also allows a publisher to perform management operations on ad slot groups. A publisher may select one or more ad slot groups on which to perform a management operation by making one or more selections using selection controls 420. The publisher may then select one of a group of management controls 222a-b to delete an ad slot group or edit the properties of an ad slot group, respectively. For example, the publisher may select the edit control 422b and change the keywords associated with an ad slot group. In addition, the publisher may select a control 424 to request that a new online ad slot group be created.

The online ad slot area 404 includes a hide control 426 that minimizes the online ad slot area 404. For example, the publisher may select the hide control 426 to request that only the name of the ad slot type and the show control 418 remain in the GUI 400. Minimizing the online ad slot area 404 moves the other ad slot areas 406 and 408 up into the space that the online ad slot area 404 previously occupied in the GUI 400. In some implementations, the other ad slot areas 406 and 408 include controls corresponding to the controls 418, 420, 422a-b, 424, and 426 in the online ad slot area 404. In some implementations, a publisher may make selections using the selection controls 420 in two or more of the ad slot areas 404, 406, and 408 and then select a management operation such as one of the controls 422a-b. This can allow a publisher to manage ad slot groups having two or more different types using one management operation.

The audio ad slot area 406 presents content publishing information for audio ad slots, such as ad slots presented within a commercial break during a radio broadcast or ad slots in a telemarketing program. The audio ad slot area 406 includes an audio ad slot list 428. The list 428 shows content publishing information for groups of audio ad slots during the time period selected in the control 412 within the ad slot summary area 402. Particularly, the list 428 includes a row for each audio ad slot group. As with the online ad slot list 414, the audio ad slot list 428 includes columns in each row for an ad slot group name, a status, and a revenue of the ad slot group during the selected time period, for example. The list 428 also includes, in one implementation, a start date for each audio ad slot group, an end date, a number of times ad content was published (e.g., ad plays), and a number of times ad content was presented to an end user as a result of publishing the ad slot group (e.g., the number of impressions).

The print ad slot area 408 presents content publishing information for print ad slots, such as ad slots in a newspaper or magazine. The print ad slot area 408 includes a print ad slot list 430. The list 430 shows content publishing information for print ad slot groups during the time period selected in the control 412 within the ad slot summary area 402. Particularly, the list 430 includes a row for each print ad slot group. As with the online ad slot list 414, the print ad slot list 430 includes, for example, columns in each row for an ad slot group name, a status, and a revenue of the ad slot group during the selected time period. The list 430 also includes, for example, a number of publisher products (e.g., newspapers) in which the ad slots are included, a number of print ads accepted for presentation, and a number of times the accepted print ads were presented using the print ad slots (e.g., the number of impressions).

The other ad slot area 410 allows a publisher to create ad campaigns for other media types in which the publisher is not already providing ad slots. The other ad slot area 410 includes a control 432 that allows a publisher to create, for example, a television ad slot group, such as ad slots within a commercial break in a television medium.

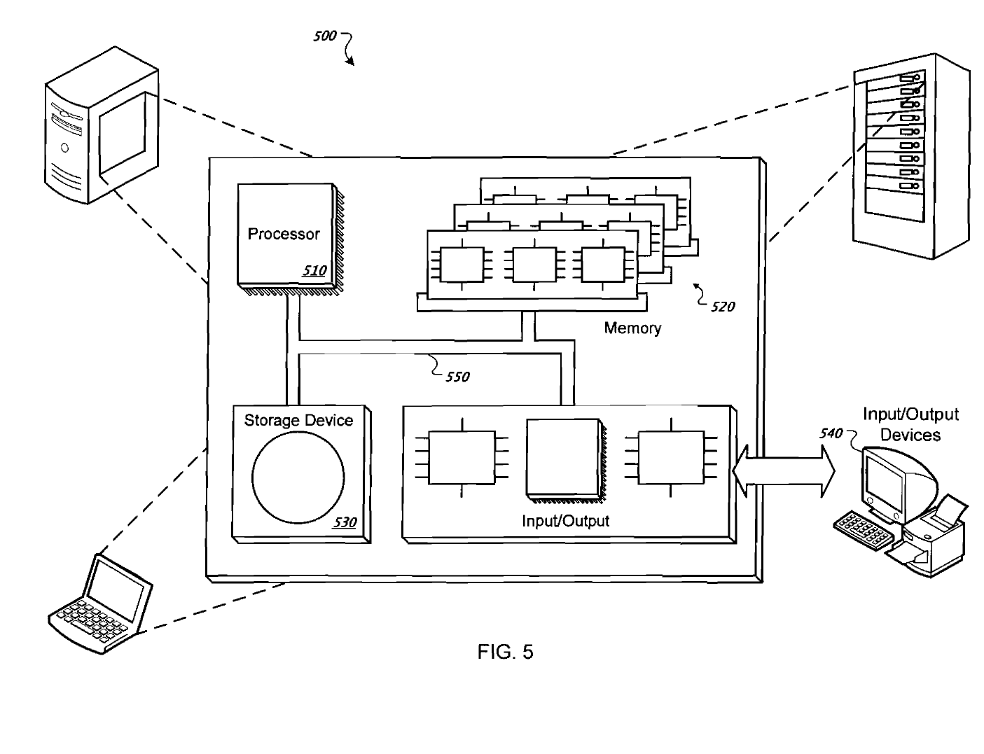

FIG. 5 is a schematic diagram of a generic computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540. The system may be implemented, for example, on an individual computer 500 or on a parallel cluster of computer systems 500 distributed over a network.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for providing information about content distribution, the method comprising:
receiving a request for information regarding at least one content distribution activity that has previously been created to be performed in at least one of a plurality of media types;
obtaining content distribution information regarding the at least one content distribution activity; and
presenting the content distribution information in a graphical user interface that is configured to display content distribution activities for each of the media types.

2. The computer-implemented method of claim 1, wherein the request is associated with an account registered in a multimedia content distribution platform, further comprising:
identifying, before presenting the content distribution information, the at least one content distribution activity in the multimedia content distribution platform using the account.

3. The computer-implemented method of claim 1, wherein the at least one content distribution activity is an advertisement campaign created to be presented in one of the plurality of media types.

4. The computer-implemented method of claim 1, wherein the plurality of media types includes at least one selected from: an online medium, a wireless medium, an audio medium, a radio medium, a visual medium, an audiovisual medium, a television medium, a telephone medium, a print medium, and combinations thereof.

5. The computer-implemented method of claim 1, wherein several content distribution activities have previously been created to be performed in at least some of the plurality of media types, further comprising:
aggregating at least part of content distribution information for each of the several content distribution activities into an aggregate content distribution information; and
presenting the aggregate content distribution information in the graphical user interface.

6. The computer-implemented method of claim 1, further comprising:
receiving an input to change a setting of the at least one content distribution activity, the input being generated under guidance of the graphical user interface; and
modifying, in response to the input, an instruction configured for causing the at least one content distribution activity to be performed.

7. The computer-implemented method of claim 6, wherein modifying the instruction comprises performing at least one selected from the group consisting of: starting the activity, pausing the activity, ending the activity, deleting the activity, setting a budget for the activity, changing a characteristic of the activity, and combinations thereof.

8. The computer-implemented method of claim 1, further comprising:
receiving an input to create another content distribution activity, the input being generated under guidance of the graphical user interface and indicating at least one of the plurality of media types to be used for the other content distribution activity; and
creating, in response to the input, the other content distribution activity to be performed in the indicated media type.

9. A computer program product tangibly embodied in a computer-readable medium and comprising instructions that when executed by a processor perform a method for providing information about content distribution, the method comprising:
receiving a request for information regarding at least one content distribution activity that has previously been created to be performed in at least one of a plurality of media types;
obtaining content distribution information regarding the at least one content distribution activity; and
presenting the content distribution information in a graphical user interface that is configured to display content distribution activities for each of the media types.

10. A system comprising:
a multimedia content distribution platform configured to manage at least one content distribution activity in any of a plurality of media types; and
a graphical user interface interacting with the a multimedia content distribution platform and configured to: (i) guide submission of a request to the multimedia content distribution platform for information regarding the at least one content distribution activity; and (ii) present content distribution information relating to the at least one content distribution activity that the multimedia content distribution platform obtains.

11. The system of claim 10, wherein several content distribution activities have previously been created to be performed in at least some of the plurality of media types, and wherein the multimedia content distribution platform is configured to aggregate at least part of content distribution information for each of the several content distribution activities into an aggregate content distribution information, and present the aggregate content distribution information in the graphical user interface.

12. The system of claim 10, further comprising:
an activity management module configured to at least initiate content distribution activities in any of the plurality of media types.

13. The system of claim 12, wherein content distribution activities in at least one of the plurality of media are performed by a system other than the activity management module, and wherein the activity management module is configured to communicate with the other system regarding the content distribution activities in the at least one of the plurality of media.

14. The system of claim 12, wherein the multimedia content distribution platform is configured for:
receiving an input to change a setting of the at least one content distribution activity, the input being generated under guidance of the graphical user interface; and
modifying, in response to the input, an instruction for the activity management module regarding the at least one content distribution activity.

15. The system of claim 12, wherein the multimedia content distribution platform is configured for:
receiving an input to create another content distribution activity, the input being generated under guidance of the graphical user interface and indicating at least one of the plurality of media types to be used for the other content distribution activity; and
creating, in response to the input and for the activity management module, the other content distribution activity to be performed in the indicated media type.

16. A computer program product tangibly embodied in a computer-readable medium, the computer program product including instructions that, when executed, generate on a display device a graphical user interface for providing information about content distribution, the graphical user interface including:
a plurality of areas regarding content distribution activities, each of the areas being associated with at least one of a plurality of media types and being configured for managing at least one content distribution activity that is created to be performed in the associated media type and informing about the at least one content distribution activity.

17. The computer program product of claim 16, wherein several content distribution activities have previously been created to be performed in at least some of the plurality of media types, and wherein the graphical user interface further includes:
an area for presenting an aggregate content distribution information, the aggregate content distribution information generated by aggregating at least part of content distribution information for each of the several content distribution activities.

18. The computer program product of claim 16, wherein the graphical user interface further includes:
an input control for generating an input to change a setting of the at least one content distribution activity, wherein, in response to the input, an instruction configured for causing the at least one content distribution activity to be performed is modified.

19. The computer program product of claim 16, wherein the graphical user interface further includes:
an input control for generating an input to create another content distribution activity, the input indicating at least one of the plurality of media types to be used for the other content distribution activity, wherein, in response to the input, the other content distribution activity to be performed in the indicated media type is created.

20. A computer-implemented method for managing multiple media type distribution in an advertising campaign, the method comprising:
identifying plural distribution media types for inclusion in at least one campaign;
setting distribution characteristics in each of the plural distribution media types for the campaign;
presenting campaign information to a user that aggregates results over more than one of the plural distribution media types.

21. The computer-implemented method of claim 20, further comprising managing activities for the plural distribution media types.

22. The computer-implemented method of claim 21, wherein managing the activities comprises at least initiating the activities to be performed in the respective plural distribution media types.

23. The computer-implemented method of claim 21, wherein managing the activities further comprises changing an aspect of an activity for at least one of the plural distribution media types.

24. The computer-implemented method of claim 23, wherein the change is applied to several of the plural distribution media types and wherein the change is initiated by a single command generated by a user.

25. A computer program product tangibly embodied in a computer-readable medium and comprising instructions that when executed by a processor perform a method for managing multiple media-type distribution in an advertising campaign, the method comprising:
identifying plural distribution media types for inclusion in at least one campaign;
setting distribution characteristics in each of the plural distribution media types for the campaign;
presenting campaign information to a user that aggregates results over more than one of the plural distribution media types.
